(19) United States
(12) Patent Application Publication
(10) Pub. No.: US 2021/0033450 A1
(43) Pub. Date: Feb. 4, 2021

(54) Vibration Waveform DC Disturbance Removal

(71) Applicant: Computational Systems, Inc., Knoxville, TN (US)

(72) Inventors: Anthony J. Hayzen, Knoxville, TN (US); John W. Willis, Oak Ridge, TN (US)

(73) Assignee: Computational Systems, Inc., Knoxville, TN (US)

(21) Appl. No.: 16/524,361

(22) Filed: Jul. 29, 2019

(51) Int. Cl. G01H 1/00; G01M 99/00

(52) U.S. Cl. CPC G01H 1/003; G01M 99/005

(57) ABSTRACT

A method for removing the DC disturbance of a vibration waveform, by receiving the vibration waveform and detecting and removing a DC component of the vibration waveform, leaving substantially only an AC component of the vibration waveform, which is stored on a non-transitory computer-readable medium.

### FIELD

This invention relates to the field of equipment vibration monitoring and analysis. More particularly, this invention relates to removing the DC disturbance component from vibration waveform data.

### INTRODUCTION

Vibration waveforms have what could be classified as two components. The first component is what is often called the direct current or DC component, which often reflects the electrical bias of the output amplifier that is boosting the vibration signal. The second component is what is often called the alternating current or AC component, which reflects the vibration signal that is produced by the accelerometer or other vibration sensing device. The AC component tends to oscillate around the level of the DC component, whatever that level might be. In many applications, the DC component is of lesser interest when analyzing the vibration of monitored equipment, while the AC component is of primary interest.

Unfortunately, if the DC component changes, it is difficult to determine what exactly has changed. For example, if the DC component suddenly increases, it is difficult to know if the increase is a result of the electrical amplifier bias or a major change in the condition of the AC vibration component. This problem is especially pronounced if the DC component is changing frequently and erratically.

Such a dramatic shift in the DC component can occur during one or more of several common events. For example, the mere placement of a vibration sensor against the equipment to be monitored can cause such a shift. Similarly, a hard, physical jolt to the monitored equipment can also produce such a shift. In a different manner, starting or stopping electrical equipment that is not adequately isolated from the vibration sensor can create such a shift. Thus, these troublesome shifts in the waveform data can be created by many different events and at various times.

When a Fast Fourier Transform is performed on the disturbed waveform, the resulting frequency spectrum can contain a significant amount of spurious low frequency components as a result of the DC disturbance. These spurious signals can be misinterpreted by the technician as problems with the monitored equipment.

What is needed, therefor, is a system that tends to address issues such as those described above, at least in part.

### SUMMARY

The above and other needs are met by a method for removing DC disturbance in a vibration waveform, by receiving the vibration waveform and detecting and removing a DC disturbance component of the vibration waveform, leaving substantially only an AC component of the vibration waveform, which is stored on a non-transitory computer-readable medium.

In various embodiments according to this aspect of the invention, the step of detecting the DC disturbance component of the vibration waveform comprises computing a running average of the vibration waveform and using the running average as the DC component of the vibration waveform. In some embodiments, the step of removing the DC component of the vibration waveform includes subtracting the running average of the vibration waveform from the vibration waveform. In some embodiments, the step of receiving the vibration waveform includes receiving the vibration waveform directly from a vibration sensor. In some embodiments, the step of receiving the vibration waveform includes receiving the vibration waveform as stored data from a memory.

In some embodiments, the step of storing the AC component of the vibration waveform includes storing the AC component of the vibration waveform in a memory that located locally where the detecting and removing of the DC component of the vibration waveform is performed. In some embodiments, the step of storing the AC component of the vibration waveform includes storing the AC component of the vibration waveform in a memory that is located remotely from where the detecting and removing of the DC component of the vibration waveform is performed. In some embodiments, an FFT is performed on the AC component of the vibration waveform to produce a vibration spectrum.

According to another aspect of the invention there is described a non-transitory, computer-readable storage medium having stored thereon a computer program with a set of instructions for causing a computer to remove the DC disturbance component in a vibration waveform. The vibration waveform is received, and a DC component of the vibration waveform is detected and removed, leaving substantially only an AC component of the vibration waveform. The AC component of the vibration waveform is then stored on a non-transitory computer-readable medium.

In various embodiments according to this aspect of the invention, the step of detecting the DC component of the vibration waveform includes computing a running average of the vibration waveform and using the running average as the DC component of the vibration waveform. In some embodiments, the step of removing the DC component of the vibration waveform includes subtracting the running average of the vibration waveform from the vibration waveform. In some embodiments, the step of receiving the vibration waveform includes receiving the vibration waveform directly from a vibration sensor. In some embodiments, the step of receiving the vibration waveform includes receiving the vibration waveform as stored data from a memory.

In some embodiments, the step of storing the AC component of the vibration waveform includes storing the AC component of the vibration waveform in a memory that is located locally to where the detecting and removing of the DC component of the vibration waveform is performed. In some embodiments, the step of storing the AC component of the vibration waveform includes storing the AC component of the vibration waveform in a memory that is located remotely from where the detecting and removing of the DC component of the vibration waveform is performed. In some embodiments, an FFT is performed on the AC component of the vibration waveform to produce a vibration spectrum.

According to yet another aspect of the invention, there is described an apparatus for removal of the DC disturbance component in a vibration waveform. The apparatus has an input to receive the vibration waveform, and a processor that detects and removes the DC disturbance component of the vibration waveform, leaving substantially only an AC component of the vibration waveform remaining. A non-transitory storage medium stores the AC component of the vibration waveform.

In various embodiments according to this aspect of the invention, the input includes a vibration sensor that produces a live vibration waveform. In some embodiments, the input includes a memory that provides a stored vibration waveform. In some embodiments, an interface is adapted to receive instruction from and present information to an operator.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a plot of a waveform showing the effect of a DC disturbance component according to an embodiment of the present invention.

FIG. 2 is a plot of a waveform, where the shift in the DC disturbance component of the waveform has been identified, according to an embodiment of the present invention.

FIG. 3 is a plot of a waveform where the DC disturbance component of the waveform has been removed, according to an embodiment of the present invention.

FIG. 4 is a plot of a spectrum generated from a waveform with a DC disturbance component, according to an embodiment of the present invention.

FIG. 5 is a plot of a spectrum generated from a waveform where the DC disturbance component has been removed in the underlying waveform data, according to an embodiment of the present invention.

FIG. 6 depicts a flow chart of a method for removing the DC disturbance component in the underlying waveform, according to an embodiment of the present invention.

FIG. 7 depicts in graphical form how the DC disturbance component in the underlying waveform is removed, according to an embodiment of the present invention,

FIG. 8 depicts a functional block diagram of a computing apparatus for implementing the removal of the DC disturbance component from a waveform signal according to an embodiment of the present invention.

### DESCRIPTION

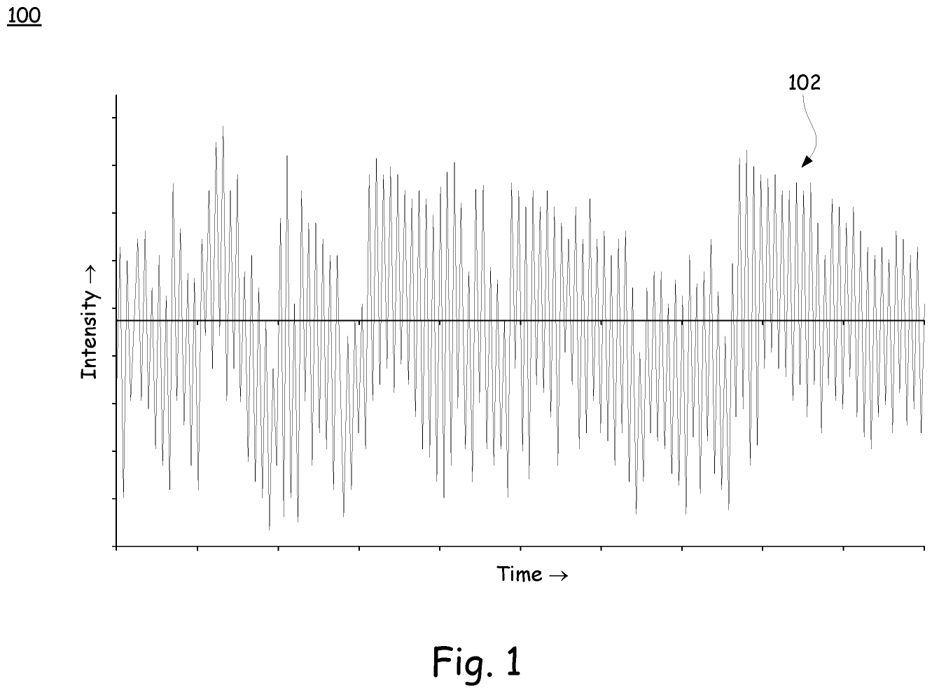

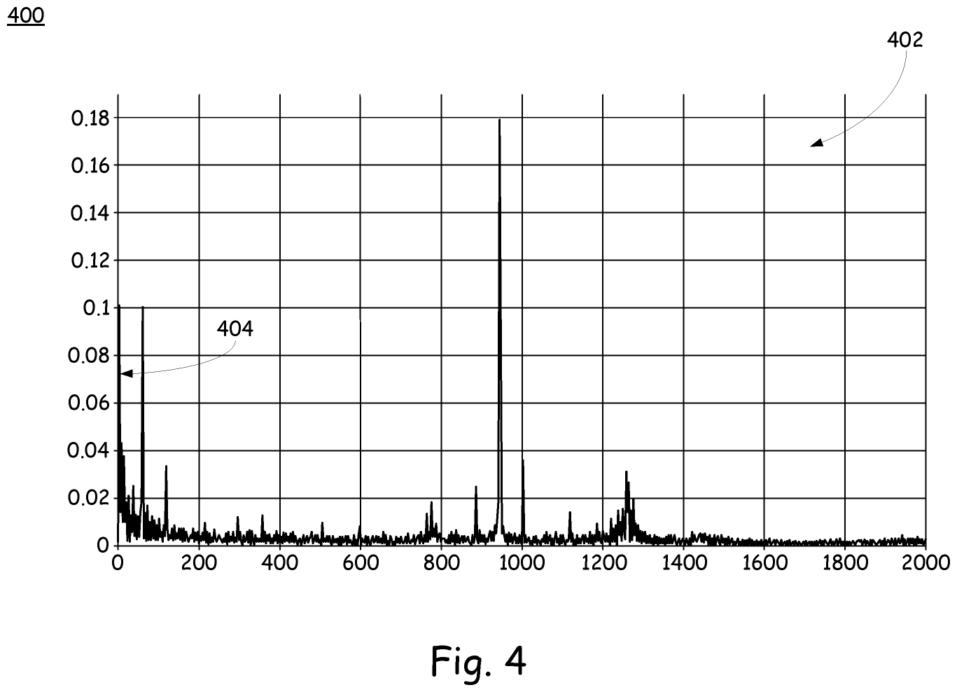

With reference now to FIG. 1, there is depicted a plot 100 of a waveform 102. By just looking at the waveform 102, it is difficult to discern if the waveform 102 represents the actual vibration profile of the monitored equipment, or if there are spurious signals in the DC component of the waveform 102. FIG. 4 depicts a representational plot 400 of a spectrum 402 that is created such as by performing an FFT on the waveform 102. As can be seen in FIG. 4, there are some relatively strong low-frequency peaks 404 present in the spectrum 402.

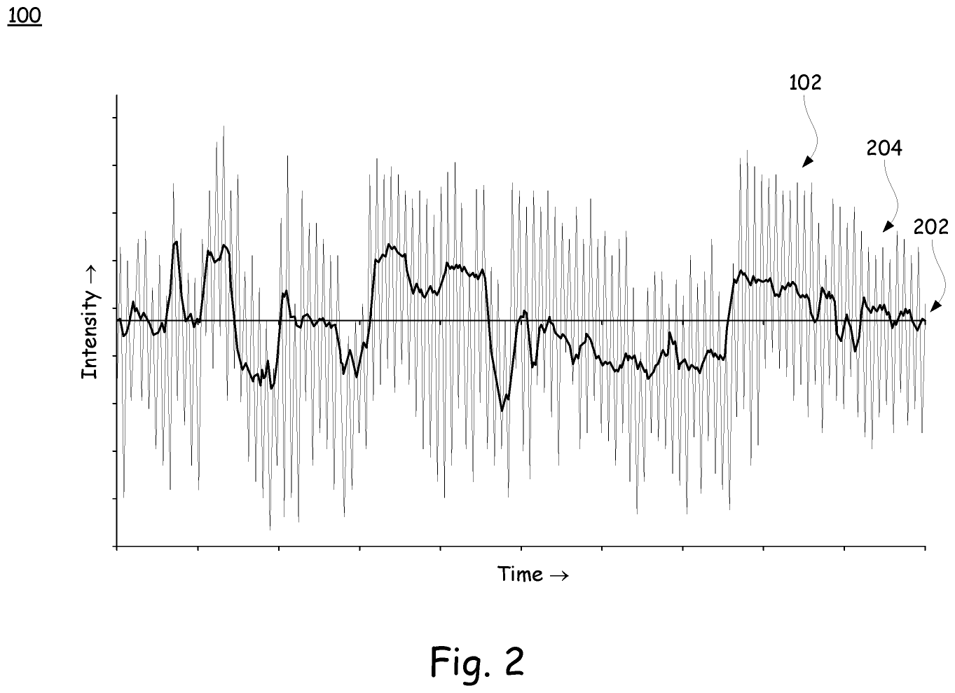

With reference now to FIG. 2, there is depicted the waveform 102 where the DC component 202 of the waveform 102 has been identified. A representational method for identifying the DC component 202 is presented hereafter, but it is appreciated that there are many methods by which the DC component 202 within a waveform 102 could be identified. As depicted, the DC component 202 of the waveform 102 is extremely unsteady and rises and falls to many different levels. This is not normal vibrational activity and represents an anomaly in the DC component 202 of the waveform 102 that is obfuscating the changes in the AC component 204 that represents the vibrational data of greater interest.

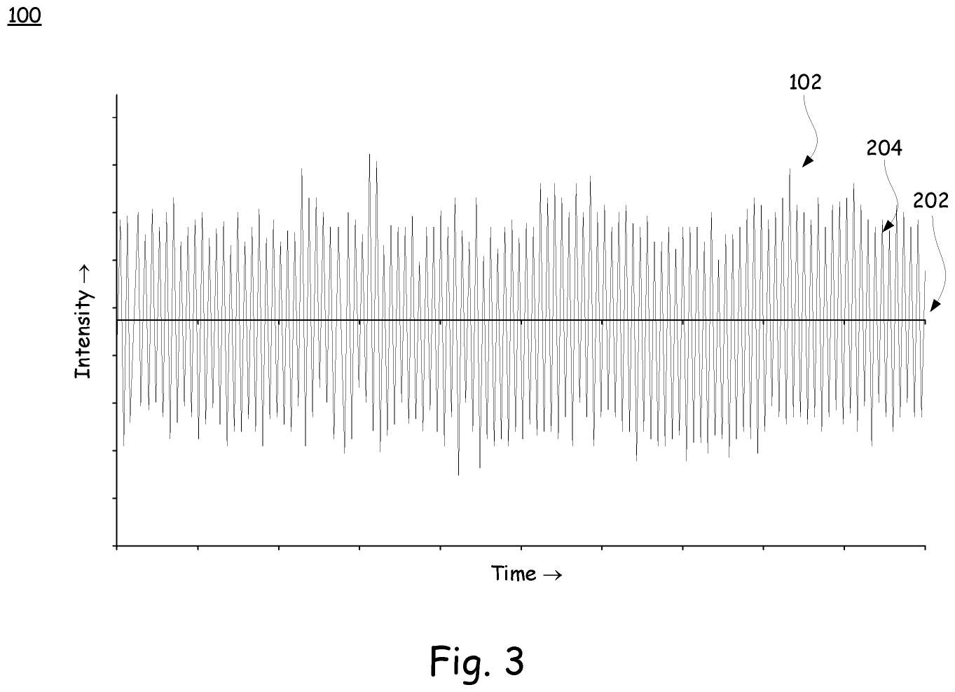

With reference now to FIG. 3, there is depicted the waveform 102 where the DC disturbance component 202 of the waveform 102 has been removed, or in other words brought to a substantially consistent level across either the entirety of or a desired portion of the duration of the waveform 102. In some embodiments, this produces a DC component 202 that is represented by a straight, flat line that is parallel to the x-axis (time axis) of the plot 100. In other embodiments, the DC component 202 is substantially removed within a given tolerance around a flat line. A representational method for removing the DC component 202 is presented hereafter, but it is appreciated that there are many methods by which the DC component 202 within a waveform 102 could be removed.

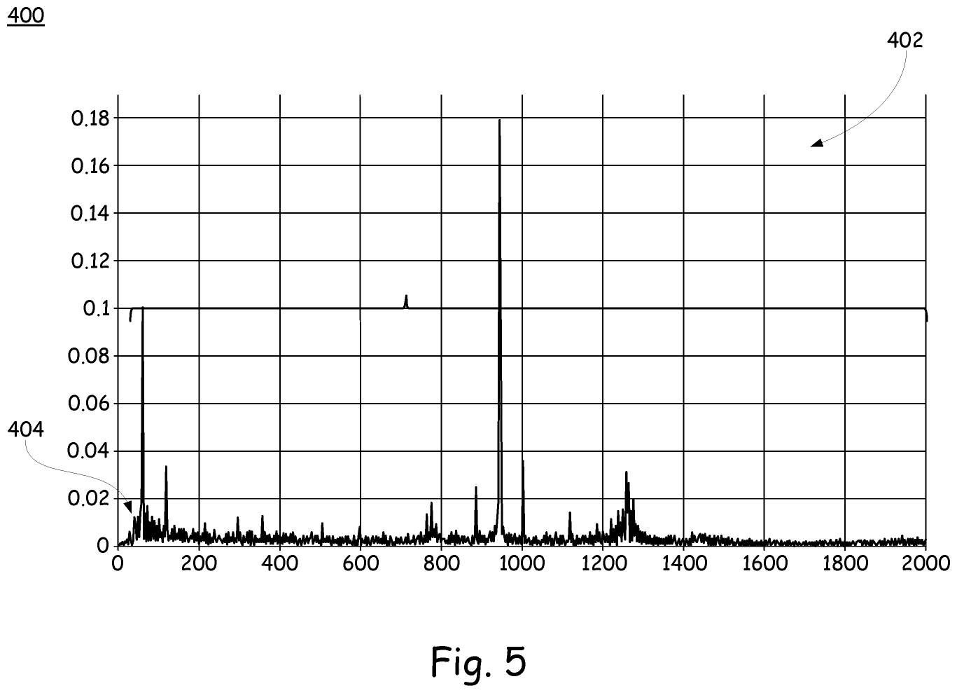

With reference now to FIG. 5, there is depicted the plot 400 of the spectrum 402 of the waveform with the DC disturbance component removed 102 as depicted in FIG. 3. As can be seen in FIG. 5, the low frequency peaks 404 of the waveform with the DC disturbance component removed 102 have been attenuated to some extent and are not as strong as previously depicted in the spectrum where the DC disturbance has not been removed 402 of FIG. 4. In this manner, the plot 400 of FIG. 5 represents what could be described as real or non-anomalous vibration information on the monitored equipment, on which a technician or engineer can base informed and accurate decisions.

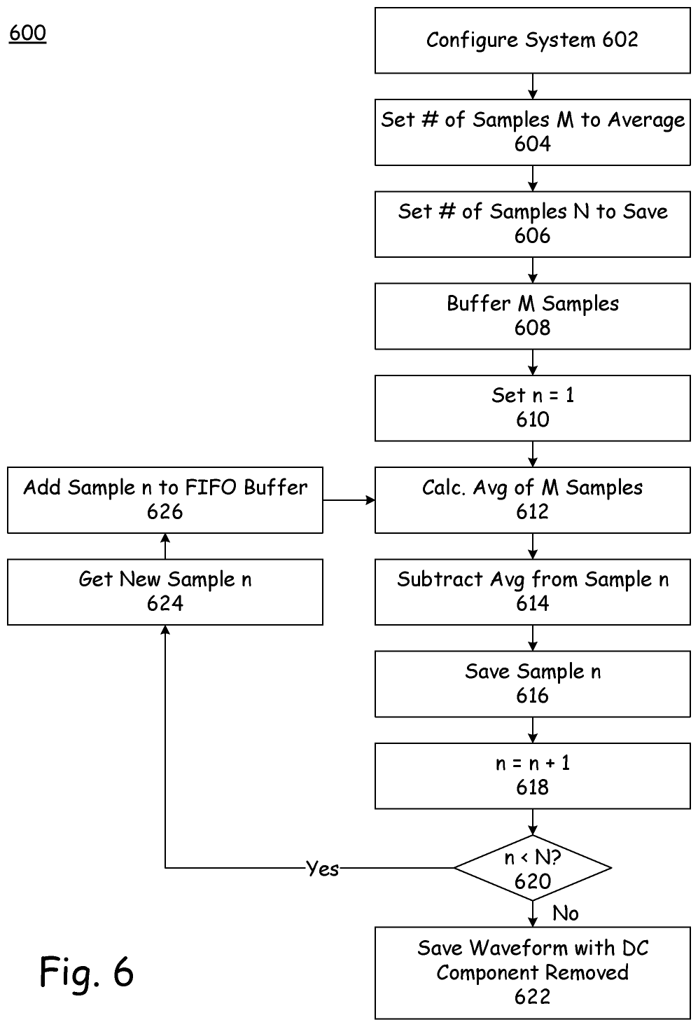

FIG. 6 provides a flowchart of a method 600 by which the DC disturbance component of the waveform 102 can be removed. As given in block 602 of the method 600, a vibration monitoring system is configured to collect a vibration waveform from the monitored equipment. In the embodiment of method 600, the DC disturbance component 202 of the waveform 102 is removed by averaging a given number of data points in the waveform 102. Thus, the number M of waveform data points or samples to average is set in block 604, and the number of waveform samples N to save is set in block 606.

The method 600 can be performed either as pre-processing on a live waveform data stream as it is produced, or on waveform data that has been saved to a storage device. Regardless of the immediate source of the waveform data, M samples of waveform data are placed in a random access memory, as given in block 608, and the sample number n is set to 1, as given in block 610. The average of M waveform samples is calculated as given in block 612, and the average so calculated is subtracted from sample n of the waveform data, as given in block 614. The sample n is then saved, as given in block 616, and the value of n is incremented by 1, as given in block 618.

If n is less than N, then the next waveform sample is read from the memory as given in block 624, and is added to the buffer for averaging, where only M samples are held in the buffer at a time, and the newly input sample pushes out an earlier-acquired sample according to a first-in-first-out methodology. The method 600 then falls back to block 612, where a new average of the M sample is calculated. This process repeats until n is equal to N, as given in block 620, at which point the DC component 202 is removed from the buffered waveform, as given in block 622, and is either passed along for further processing or saved to a non-transitory computer-readable storage device.

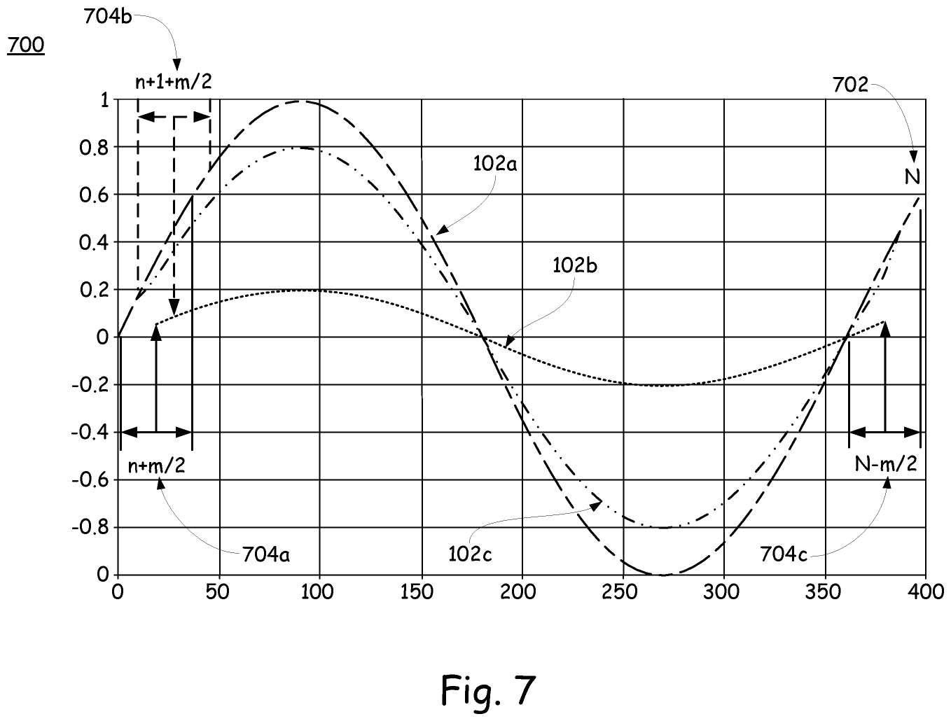

Looking now at FIG. 7, there is depicted a plot 700 that provides a graphical explanation of the method 600. The waveform 102a represents the original waveform with the anomalous DC component 202. The waveform 102b represents the moving-average DC component of the original waveform, and the waveform 102c represents the vibration waveform where the averaged DC component has been removed. The total number of points N in the waveform 102 is indicated at 702. The first averaged calculation is depicted at 704a, the second at 704b, and the final averaged calculation is depicted at 704c. Each of these produces a first, second, and final centered average as indicated. For example, the first centered average is at n+m/2 of n−m/2 to n+m/w of m+1 points, where m is the number of points to average, and so forth for all n in N.

The number of waveform samples to average is set, in one embodiment, to an integral number of the equipment turning speed, and includes two full rotational cycles of the equipment. This helps to capture bearing faults that might appear at about one-half of the turning speed. The number of samples to average can be a user-configurable number, or can be set to a default value, depending on the type of faults the equipment may exhibit.

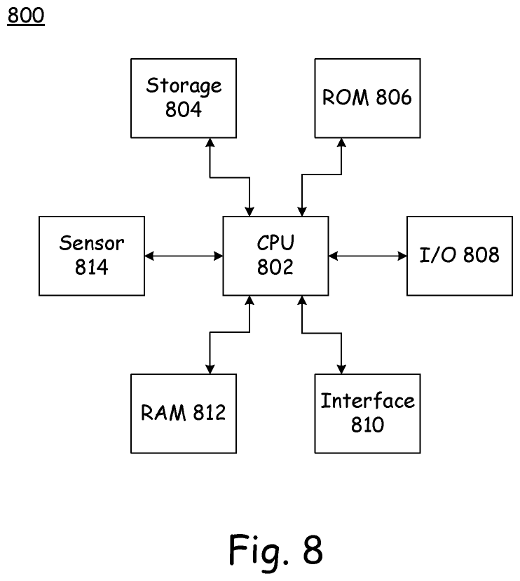

With reference now to FIG. 8, there is depicted one embodiment of a computerized apparatus 800 capable of performing the actions as described herein. In this embodiment, the apparatus 800 is locally under the control of the central processing unit 802, which controls and utilizes the other modules of the apparatus 800 as described herein. As used herein, the word module refers to a combination of both software and hardware that performs one or more designated function. Thus, in different embodiments, various modules might share elements of the hardware as described herein, and in some embodiments might also share portions of the software that interact with the hardware.

The embodiment of apparatus 800 as depicted in FIG. 8 includes, for example, a storage module 804 such as a hard drive, tape drive, optical drive, or some other relatively long-term data storage device. A read-only memory module 806 contains, for example, basic operating instructions for the operation of the apparatus 800. An input-output module 808 provides a gateway for the communication of data and instructions between the apparatus 800 and other computing devices, networks, or data storage modules. An interface module 810 includes, for example, keyboards, speakers, microphones, cameras, displays, mice, and touchpads, and provides means by which a technician can observe and control the operation of the apparatus 800. A random-access memory module 812 provides short-term storage for data that is being buffered, analyzed, or manipulated and programming instructions for the operation of the apparatus 800. Some embodiments of the apparatus 800 include the vibration sensor 814, which senses vibration from the rotating equipment and provides the vibration signal representing the sensed vibration. For example, an amplified accelerometer is used as the sensor 814 in some embodiments.

In one embodiment, the apparatus 800 receives stored waveform data through the input/output 808. In other embodiments, the apparatus 800 receives waveform data from the vibration sensor 814. In either embodiment, the apparatus 800 removes the DC disturbance component in the waveform data as described herein, and then sends the adjusted waveform data out through the input/output 808 for remote storage or further processing, or directly to the storage module 804. In some embodiments the steps of the method as described herein are embodied in a computer language on a non-transitory medium that is readable by the apparatus 800 of FIG. 8, and that enables the apparatus 800 to implement the removal of the DC disturbance component as described herein.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for removing the DC disturbance component of a vibration waveform, the method comprising the steps of:
receiving the vibration waveform,
detecting a DC component of the vibration waveform,
removing the DC component of the vibration waveform, leaving substantially only an AC component of the vibration waveform remaining, and
storing the AC component of the vibration waveform on a non-transitory computer-readable medium.

2. The method of claim 1, wherein the step of detecting the DC component of the vibration waveform comprises computing a running average of the vibration waveform and using the running average as the DC component of the vibration waveform.

3. The method of claim 2, wherein the step of removing the DC component of the vibration waveform comprises subtracting the running average of the vibration waveform from the vibration waveform.

4. The method of claim 1, wherein the step of receiving the vibration waveform comprises receiving the vibration waveform directly from a vibration sensor.

5. The method of claim 1, wherein the step of receiving the vibration waveform comprises receiving the vibration waveform as stored data from a memory.

6. The method of claim 1, wherein the step of storing the AC component of the vibration waveform comprises storing the AC component of the vibration waveform in a memory that located locally where the detecting and removing of the DC component of the vibration waveform is performed.

7. The method of claim 1, wherein the step of storing the AC component of the vibration waveform comprises storing the AC component of the vibration waveform in a memory that is located remotely from where the detecting and removing of the DC component of the vibration waveform is performed.

8. The method of claim 1, further comprising performing an FFT on the AC component of the vibration waveform to produce a vibration spectrum.

9. A non-transitory, computer-readable storage medium having stored thereon a computer program comprising a set of instructions for causing a computer to remove the DC disturbance component of a vibration waveform by performing the steps of:
receiving the vibration waveform,
detecting a DC component of the vibration waveform,
removing the DC component of the vibration waveform, leaving substantially only an AC component of the vibration waveform remaining, and
storing the AC component of the vibration waveform on a non-transitory computer-readable medium.

10. The storage medium of claim 9, wherein the step of detecting the DC component of the vibration waveform comprises computing a running average of the vibration waveform and using the running average as the DC component of the vibration waveform.

11. The storage medium of claim 10, wherein the step of removing the DC component of the vibration waveform comprises subtracting the running average of the vibration waveform from the vibration waveform.

12. The storage medium of claim 9, wherein the step of receiving the vibration waveform comprises receiving the vibration waveform directly from a vibration sensor.

13. The storage medium of claim 9, wherein the step of receiving the vibration waveform comprises receiving the vibration waveform as stored data from a memory.

14. The storage medium of claim 9, wherein the step of storing the AC component of the vibration waveform comprises storing the AC component of the vibration waveform in a memory that is located locally to where the detecting and removing of the DC component of the vibration waveform is performed.

15. The storage medium of claim 9, wherein the step of storing the AC component of the vibration waveform comprises storing the AC component of the vibration waveform in a memory that is located remotely from where the detecting and removing of the DC component of the vibration waveform is performed.

16. The storage medium of claim 9, further comprising performing an FFT on the AC component of the vibration waveform to produce a vibration spectrum.

17. An apparatus for removing the DC disturbance component of a vibration waveform, the apparatus comprising:
an input adapted to receive the vibration waveform,
a processor adapted to,
detect a DC component of the vibration waveform, and
remove the DC component of the vibration waveform, leaving substantially only an AC component of the vibration waveform remaining, and
a non-transitory storage medium adapted to store the AC component of the vibration waveform.

18. The apparatus of claim 17, wherein the input comprises a vibration sensor producing a live vibration waveform.

19. The apparatus of claim 17, wherein the input comprises a memory providing a stored vibration waveform.

20. The apparatus of claim 17 further comprising an interface adapted to receive instruction from and present information to an operator.
